(19) United States
(12) Patent Application Publication
(10) Pub. No.: US 2025/0246669 A1
(43) Pub. Date: Jul. 31, 2025

(54) BATTERY COMPONENT FABRICATION METHOD AND SYSTEM

(71) Applicant: Ford Global Technologies, LLC, Dearborn, MI (US)

(72) Inventors: Ali Rashti, Canton, MI (US); Hyukkeun Oh, Ann Arbor, MI (US); Xin Liu, Novi, MI (US); Andrew Robert Drews, Ann Arbor, MI (US)

(21) Appl. No.: 18/424,941

(22) Filed: Jan. 29, 2024

(51) Int. Cl. H01M 10/04; H01M 4/02; H01M 4/04; H01M 10/0585

(52) U.S. Cl. CPC H01M 10/0468; H01M 4/0435; H01M 10/0404; H01M 10/0585; H01M 2004/028; H01M 2220/20

(57) ABSTRACT

A battery component fabrication method includes heating at least one electrolyte layer at a pre-compression thermal chamber. After the heating at the pre-compression thermal chamber, the method compresses the at least one electrolyte layer together with an electrode to provide a multilayered structure. After the compressing, the method heats the multilayered structure at a post-compression thermal chamber.

### TECHNICAL FIELD

This disclosure relates generally to fabricating battery components and, more particularly, to components of solid-state batteries used in electrified vehicles.

### BACKGROUND

Electrified vehicles differ from conventional motor vehicles because electrified vehicles include a drivetrain having one or more electric machines. A battery pack can power the electric machines. The battery pack can include arrays of solid-state battery cells.

### SUMMARY

In some aspects, the techniques described herein relate to a battery component fabrication method, including: heating at least one electrolyte layer at a pre-compression thermal chamber; after the heating at the pre-compression thermal chamber, compressing the at least one electrolyte layer together with an electrode to provide a multilayered structure; and after the compressing, heating the multilayered structure at a post-compression thermal chamber.

In some aspects, the techniques described herein relate to a battery component fabrication method, wherein the at least one electrolyte layer is at least one solid electrolyte layer.

In some aspects, the techniques described herein relate to a battery component fabrication method, wherein the electrode is a cathode electrode.

In some aspects, the techniques described herein relate to a battery component fabrication method, further including heating during the compressing.

In some aspects, the techniques described herein relate to a battery component fabrication method, further including compressing using at least one roller of a calender.

In some aspects, the techniques described herein relate to a battery component fabrication method, wherein the at least one roller is a heated roller that heats the at least one electrolyte layer and the electrode during the compressing.

In some aspects, the techniques described herein relate to a battery component fabrication method, wherein the compressing laminates the at least one electrolyte layer to the electrode.

In some aspects, the techniques described herein relate to a battery component fabrication method, wherein the compressing plastically deforms the at least one electrolyte layer and the electrode.

In some aspects, the techniques described herein relate to a battery component fabrication method, further including heating the at least one electrolyte layer at the pre-compression thermal chamber using induction heating.

In some aspects, the techniques described herein relate to a battery component fabrication method, wherein the at least one electrolyte layer is laminated to a carrier layer when heating the at least one electrolyte layer at the pre-compression thermal chamber.

In some aspects, the techniques described herein relate to a battery component fabrication method, further including delaminating the at least one electrolyte layer from the carrier layer when providing the multilayered structure.

In some aspects, the techniques described herein relate to a battery component fabrication method, further including heating the electrode prior to compressing the at least one electrolyte layer together with the electrode.

In some aspects, the techniques described herein relate to a battery component fabrication method, wherein the pre-compression thermal chamber is a first pre-compression thermal chamber that heats the at least one electrolyte layer prior to the compressing, and further including a second pre-compression thermal chamber that heats the electrode, the first pre-compression thermal chamber separate from the second pre-compression thermal chamber.

In some aspects, the techniques described herein relate to a battery component fabrication method, further including heating the electrode in the pre-compression thermal chamber together with the at least one electrolyte layer.

In some aspects, the techniques described herein relate to a battery component fabrication method, wherein the at least one electrolyte layer includes a first electrolyte layer and a second electrolyte layer that sandwich the electrode within the multilayered structure.

In some aspects, the techniques described herein relate to a battery component fabrication system, including: at least one pre-compression thermal chamber that heats at least one electrolyte layer; a compression station that receives the at least one electrolyte layer from the at least one pre-compression thermal chamber and compresses the at least one electrolyte layer together with an electrode to provide a multilayered structure; and at least one post-compression thermal chamber that heats the multilayered structure.

In some aspects, the techniques described herein relate to a battery component fabrication system, wherein the at least one electrolyte layer is laminated to a carrier film when heated at the at least one pre-compression thermal chamber.

In some aspects, the techniques described herein relate to a battery component fabrication system, wherein the compression station includes at least one calender roller that compresses.

In some aspects, the techniques described herein relate to a battery component fabrication system, wherein the compression station includes at least one calender roller is configured to heat the at least one electrolyte layer.

In some aspects, the techniques described herein relate to a battery component fabrication system, wherein the at least one electrolyte layer is a solid electrolyte layer of an electrified vehicle battery cell.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective view of the traction battery pack from the electrified vehicle of FIG. 1.

FIG. 3 illustrates a battery cell from the traction battery pack of FIG. 2.

FIG. 3A illustrates a close-up, schematic view of layers within the battery cell of FIG. 3.

FIG. 4 schematically illustrates selected portions of a battery assembly system used to fabricate battery components of the array of FIG. 3 according to an exemplary aspect of the present disclosure.

FIG. 5 schematically illustrates a close-up view of a calendering station from the system of FIG. 4.

FIG. 6 schematically illustrates selected portions of a battery component fabrication system used to fabricate battery components of the array of FIG. 3 according to yet another exemplary aspect of the present disclosure.

FIG. 7 illustrates the flow of an example method of fabricating components of the array of FIG. 3.

### DETAILED DESCRIPTION

This disclosure details processes for fabricating components of solid-state batteries. The processes can heat an electrolyte layer before and after compressing the electrolyte layer together with an electrode.

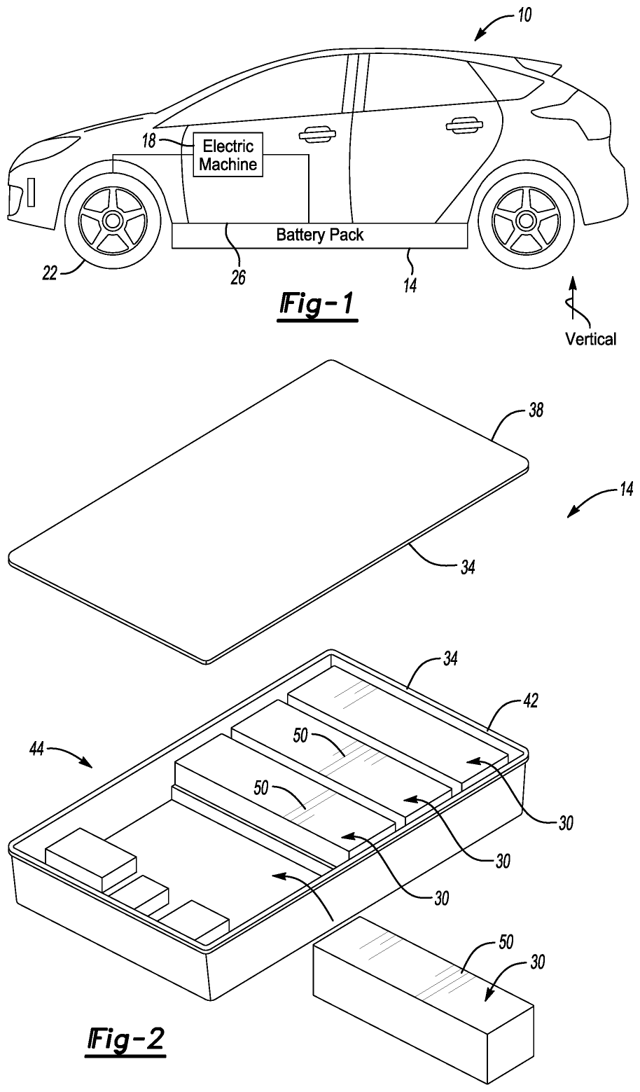

With reference to FIG. 1, an electrified vehicle 10 includes a battery pack 14, an electric machine 18, and wheels 22. The battery pack 14 powers an electric machine 18, which can convert electrical power to mechanical power to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the battery pack 14 includes a plurality of battery arrays 30 held within an enclosure assembly 34. In the exemplary embodiment, the enclosure assembly 34 includes an enclosure cover 38 and an enclosure tray 42. The enclosure cover 38 is secured to the enclosure tray 42 to provide an interior area 44 that houses the plurality of battery arrays 30. The enclosure cover 38, the enclosure tray 42, or both, can be a metal or metal alloy such as

The battery arrays 30 each includes a plurality of battery cells 50 (or simply, “cells”) stacked side-by side relative to each other. The battery cells 50 are for supplying electrical power to various components of the electrified vehicle 10. The battery cells 50 are solid-state battery cells, which include solid electrodes and a solid electrolyte, instead of the liquid or polymer gel electrolytes found in lithium-ion or lithium polymer batteries.

A plurality of the battery cells 50 are arranged side-by-side to provide the battery arrays 30. Although a specific number of cells 50 and arrays 30 are illustrated in the various figures of this disclosure, the battery pack 14 could include any number of arrays 30 having any number of cells 50. In other words, this disclosure is not limited to the specific configuration of cells 50 and arrays 30 shown in FIG. 2.

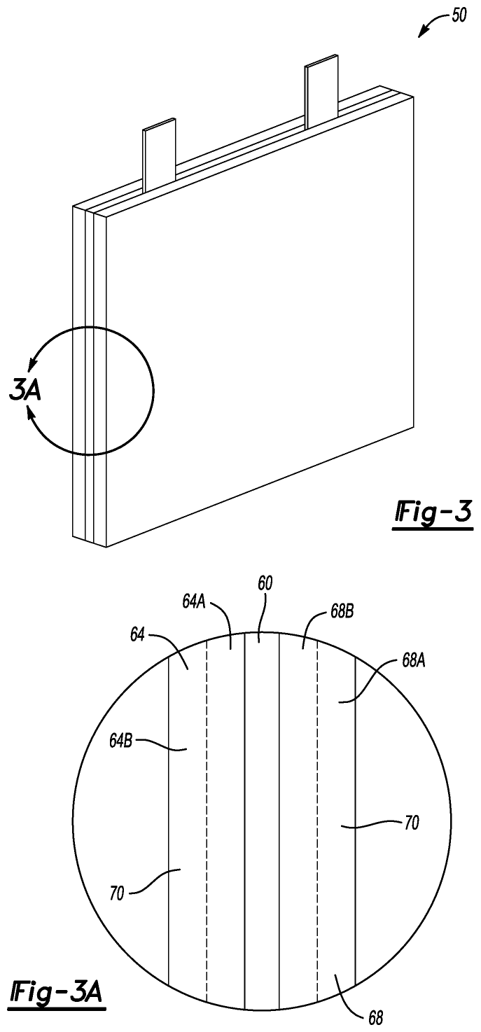

Referring to FIGS. 3 and 3A, the battery cells 50, in this example, each include a separator or electrolyte layer 60 sandwiched between an anode 64 and a cathode 68. The electrolyte layer 60 can be a sulfide solid electrolyte.

The anode 64 and the cathode 68 are each electrodes 70. The anode 64 can include an anode coating 64A on at least one side of an anode current collector 64B. The anode coating 64A can be a composite consisting of an anode active material, and additionally, may include a polymer binder, conductive additives and a solid electrolyte (anolyte) or some combination of these. The anode current collector 64B can be copper, carbon coated copper, nickel or stainless steel. The cathode 68 can include a cathode coating 68A and a cathode current collector 68B. The cathode coating 68A may be a composite that consists of cathode active material and additionally may include a polymer binder, a conductive additives and a solid electrolyte (catholyte) or some combination of these. The cathode current collector 68B can be aluminum, carbon coated aluminum, nickel or stainless steel.

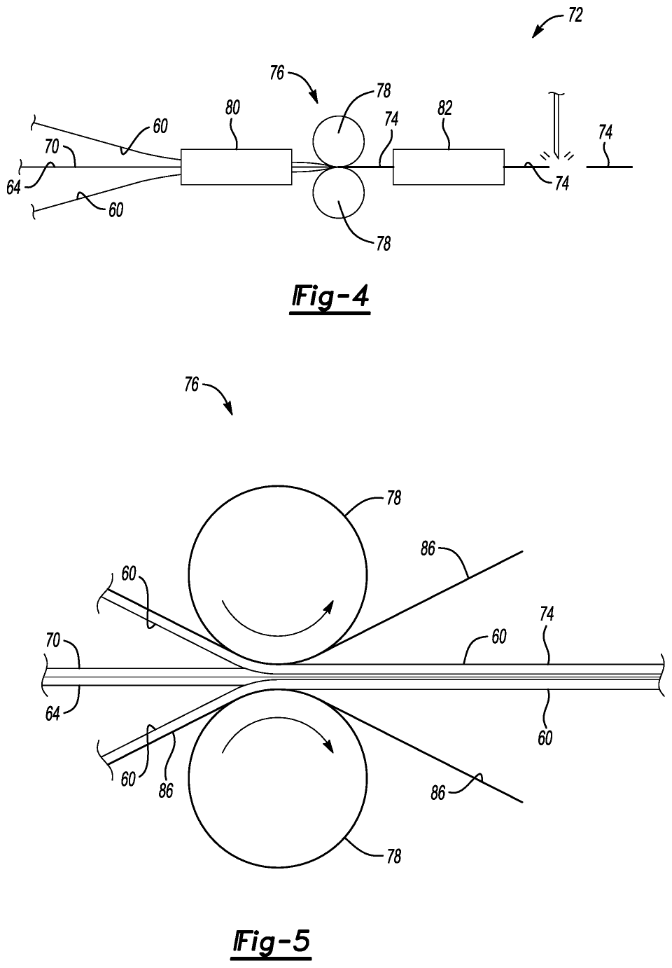

With reference now to FIG. 4 and reference again to FIGS. 2-3A, in the exemplary embodiment, a battery component fabrication system 72 is used when fabricating the stack of the battery cells 50 that form the battery arrays 30. The example component fabrication system 72 is used to secure electrolyte layers 60 to opposite sides of one of the electrodes 70, here the anode 64. The compression can laminate the electrolyte layers 60 to opposing sides of the electrode 70 to provide a multilayered structure 74.

In the example multilayered structure 74, the electrode 70 is sandwiched between two electrolyte layers 60. In another example, the system 72 is used to secure one electrolyte layer 60 to one side of the electrode 70 to provide a multilayered structure.

In the exemplary embodiment, a calendering station 76 having at least one calender roller 78—here a set of calender rollers—is used to compress the electrode 70 between the electrolyte layers 60. The compression can plastically deform the electrolyte layers 60 and the electrode 70. The at least one calender roller 78 can be a heated to heat the electrolyte layers 60 and the electrode 70 during compression. Heating can facilitate lamination and densification during compression.

In the exemplary embodiment, the electrode 70 and the electrolyte layers 60 are heated prior to compression by the calendering station 76. The heating prior to compression occurs within at least one pre-compression thermal chamber 80. The heating prior to compression can facilitate making an interface with each other for the electrolyte layers 60 and the electrode 70. The required pressure for lamination is further reduced as the electrolyte layers 60 and the electrode 70 can more easily undergo plastic deformation. The heating can include raising the temperature of the electrode 70 and the electrolyte layers 609 up to or below the melting temperature of the binder, which, in some examples, can decrease spring back after compression and lead to relatively high densification rates.

After compression within the calendering station 76, the multilayered structure 74 is routed through at least one post-compression thermal chamber 82. The post-compression thermal chamber 82 can raise or lower a temperature of multilayered structure 74, which may help mitigate spring-back effect and stress relaxation after compression.

After exiting the post-compression thermal chamber 82, the multilayered structure 74 can be cut to a desired size and arranged into electrodes 70, here cathodes 68, to form the battery cells 50.

Heating the electrode 70 prior to compression can set a temperature of the electrode 70 to a value that is favorable for compression by the calendering station 76. In some examples, the electrode 70 may not be heated prior to compression.

With reference to FIG. 5 and continuing reference to FIGS. 2-4, the electrolyte layers 60, prior to compression at the calendering station 76, are disposed on a carrier film 86. The carrier film 86 can be aluminum.

During assembly, the electrolyte layers 60 and the carrier films 86 are heated within the pre-compression thermal chamber 80. The electrolyte layers 60 are then, within the calendering station 76, each delaminated (separated) from the carrier film 86 and laminated onto the electrode 70. The heating at the pre-compression thermal chamber 80 can facilitate the delamination of the electrolyte layer 60 from the carrier film 86.

The pre-compression thermal chamber 80, and the other example thermal chambers of this disclosure, can rely on induction heating to heat. The induction heating approach could rely on arrays of copper coils that move over the electrolyte layer 60 and the electrode 70. In other examples, other methods of heating could be used, such as convection or microwave heating.

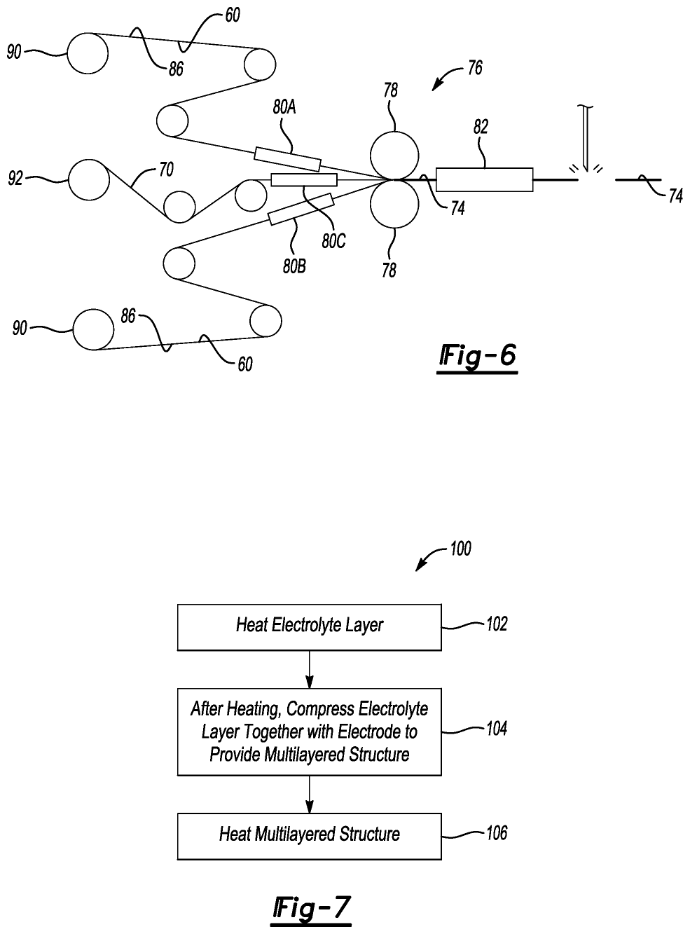

With reference now to FIG. 6, in an example, the electrolyte layers 60 secured to the carrier films 86 can be stored on respective electrolyte layer rolls 90, and the electrode 70 is stored on an electrode roll 92. During assembly, the electrolyte layers 60 secured to the carrier films 86 are unrolled and guided through respective pre-compression thermal chambers 80A and 80B. During assembly, the electrode 70 is unrolled and guided through the pre-compression chamber 80C. Using the separate pre-compression thermal chambers 80A, 80B, 80C can facilitate heating the electrolyte layers 60 more or less than the electrode 70.

The example of FIG. 6 represents a variation of the example of FIG. 4. As can be appreciated, in the example of FIG. 6, different pre-compression thermal chambers are used for each of the electrolyte layers 60 and the electrode 70.

After establishing the multilayered structure 74 by compressing at the calendering station 76, the multilayered structure 74 is passed through the post-compression thermal chamber 82 that can adjust thermal energy levels in the multilayered structure 74. The multilayered structure then can be cut to a desired size and placed between other electrodes to establish part of the battery array 30.

With reference to FIG. 7, a flow of an example method 100 of fabricating a battery component begins at a step 102 where the method heats an electrolyte layer at a pre-compression thermal chamber. After the heating at the step 102, the method 100 compresses the electrolyte layer together with at least one electrode at a step 104 to provide a multilayered strucutre. After the compressing at the step 104, the method 100, at a step 106, heats the multilayered structure at a post-compression thermal chamber.

When fabricating solid-state batteries, pressure and heat can help to laminate solid electrolyte onto electrode layers and densify the layers. Controlling a temperature of the layers can facilitate achieving high densification at relatively high-speed productions. In exemplary embodiments of this disclosure, thermal chambers placed before and after the compression site are proposed to aid the process. The pre-thermal chambers can help lowering the compaction resistance of each layer to minimizes the required pressure and exposure time. The post-thermal chamber can help to reduce the stress relaxation effects after compression.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery component fabrication method, comprising:
heating at least one electrolyte layer at a pre-compression thermal chamber;
after the heating at the pre-compression thermal chamber, compressing the at least one electrolyte layer together with an electrode to provide a multilayered structure; and
after the compressing, heating the multilayered structure at a post-compression thermal chamber.

2. The battery component fabrication method of claim 1, wherein the at least one electrolyte layer is at least one solid electrolyte layer.

3. The battery component fabrication method of claim 1, wherein the electrode is a cathode electrode.

4. The battery component fabrication method of claim 1, further comprising heating during the compressing.

5. The battery component fabrication method of claim 1, further comprising compressing using at least one set of rollers of a calender.

6. The battery component fabrication method of claim 5, wherein the at least one roller is a heated roller that heats the at least one electrolyte layer and the electrode during the compressing.

7. The battery component fabrication method of claim 1, wherein the compressing laminates the at least one electrolyte layer to the electrode.

8. The battery component fabrication method of claim 1, wherein the compressing plastically deforms the at least one electrolyte layer and the electrode.

9. The battery component fabrication method of claim 1, further comprising heating the at least one electrolyte layer at the pre-compression thermal chamber using induction heating.

10. The battery component fabrication method of claim 1, wherein the at least one electrolyte layer is laminated to a carrier layer when heating the at least one electrolyte layer at the pre-compression thermal chamber.

11. The battery component fabrication method of claim 10, further comprising delaminating the at least one electrolyte layer from the carrier layer when providing the multilayered structure.

12. The battery component fabrication method of claim 1, further comprising heating the electrode prior to compressing the at least one electrolyte layer together with the electrode.

13. The battery component fabrication method of claim 12, wherein the pre-compression thermal chamber is a first pre-compression thermal chamber that heats the at least one electrolyte layer prior to the compressing, and further comprising a second pre-compression thermal chamber that heats the electrode, the first pre-compression thermal chamber separate from the second pre-compression thermal chamber.

14. The battery component fabrication method of claim 12, further comprising heating the electrode in the pre-compression thermal chamber together with the electrolyte layer.

15. The battery component fabrication method of claim 1, wherein the at least one electrolyte layer comprises a first electrolyte layer and a second electrolyte layer that sandwich the electrode within the multilayered structure.

16. A battery component fabrication system, comprising:
at least one pre-compression thermal chamber that heats at least one electrolyte layer;
a compression station that receives the at least one electrolyte layer from the at least one pre-compression thermal chamber and compresses the at least one electrolyte layer together with an electrode to provide a multilayered structure; and
at least one post-compression thermal chamber that heats the multilayered structure.\

17. The battery component fabrication system of claim 16, wherein the at least one electrolyte layer is laminated to a carrier film when heated at the at least one pre-compression thermal chamber.

18. The battery component fabrication system of claim 16, wherein the compression station includes at least one calender roller that compresses.

19. The battery component fabrication system of claim 18, wherein the compression station includes at least one calender roller is configured to heat the at least one electrolyte layer.

20. The battery component fabrication system of claim 16, wherein the at least one electrolyte layer is a solid electrolyte layer of an electrified vehicle battery cell.
